(19) United States
(12) Patent Application Publication
(10) Pub. No.: US 2012/0136755 A1
(43) Pub. Date: May 31, 2012

(54) System and Method for Providing Virtual Fitting Experience

(76) Inventor: Jin Seok Yang, Palmdale, CA (US)

(21) Appl. No.: 13/306,931

(22) Filed: Nov. 29, 2011

Related U.S. Application Data
(60) Provisional application No. 61/417,880, filed on Nov. 29, 2010.

(51) Int. Cl. G06Q 30/06

(52) U.S. Cl. 705/26.61

(57) ABSTRACT

A system and method for providing virtual fitting experience for online clothing shopping customers include receiving customer data and clothing data, processing the customer data by a customer data module, processing the clothing data by a clothing data module; generating fitting data by graphic rendering based on the customer data and clothing data with a graphic processing module, and displaying the fitting data with an output module. In addition, a a database module that stores the customer data, the clothing data and the fitting data and a communication module that sends and receives the customer data, the clothing data or the fitting data over electronic networks. A customer inputs her body dimension and face photograph, and chooses or inputs her own clothing data. The graphic processing module renders virtual fitting result for the customer's review. Templates may be used to reduce complexity of handling details of real world data.

### CROSS REFERENCE TO RELATED APPLICATION

This application is based on provisional application No. 61/417,880 that was filed on Nov. 29, 2010 by the inventor. The contents of the provisional application is incorporated by reference as if they were fully disclosed herein.

### BACKGROUND OF THE INVENTION

1. Field of the Invention

The invention is related to online shopping for clothing or accessories. More particularly, the present invention is related to providing virtual fitting experience as part of online clothing shopping procedure.

2. Description of the Prior Art

The main weakness of online shopping is that customers cannot physically try clothes or accessories on themselves, thus, it is hard to purchase products online. Usually, customers buy products online after looking some photos of products, usually worn by professional models and photos taken by professional photographer, but sometimes they get disappointed by how products look differently when they get the shipment.

On the other hand, visiting a retail shop or a department store to buy clothing requires spending time and cost for driving, walking and waiting. Even fitting clothing itself is time consuming. In addition, the variety of clothing in a particular store is very limited compared to that found in online shopping. It is obvious that the only advantage of shopping in a physical, off-line retail shop over online shopping is that a customer can try fitting to check size and confirm the appearance that she wants.

A virtual method for fitting clothing, like other features of the cyber-world such as browsing retailers, searching clothing and ordering a garment of customer's choice, has long been in need.

### SUMMARY OF THE INVENTION

An objective of the invention is to provide a system for providing virtual fitting experience.

Another objective of the invention is to provide a method for providing virtual fitting experience.

In order to achieve the objectives, the present invention provides a system for providing virtual fitting experience comprising a customer data module that processes customer data, a clothing data module that processes clothing data, an input module that receives the customer data and the clothing data, a graphic processing module that generates fitting data, a database module that stores the customer data, the clothing data and the fitting data and an output module that displays fitting data. The fitting data comprises graphic rendering of virtual fitting based on the customer data and the clothing data.

The system further comprises a communication module that sends and receives the customer data, the clothing data or the fitting data over an electronic network.

The customer data comprises body measurement data which includes standard clothing size parameters.

The customer data further comprises one or more photographs of a customer. The customer data module analyzes the customer body photograph and generates body measurement data for the customer. The customer data module compares the customer body photograph with pre-installed body templates, chooses a closest body template, and uses body measurement data of the body template as the body measurement data for the customer.

The customer data further comprises the face image of a customer. The customer data module compares the face image with pre-installed face templates, chooses a closest face template, and morphs the customer's face image to the chosen face template.

The customer data further comprises a background image. The background image is input by the customer or chosen from pre-installed background images by the customer.

The customer data module increases or decreases one of the standard clothing size parameters for the body measurement data of a customer, whereby the body template for the customer is modified by customer's choice.

The clothing data comprises fabric design data, fabric shape data, and standard clothing size parameters for a given clothes.

The graphic processing module associates the spatial position of a graphic clothing model represented by the clothing data and the spacial position of a graphic human body model represented by the customer data.

The database module comprises a customer closet that stores the customer data, the clothing data and the fitting data for a particular customer.

The graphic processing module changes the pose of the graphic human body model and generates the fitting data for the changed pose.

The clothing data modules adjusts the fabric design data, the fabric shape data, and the standard clothing size parameters for a given clothes per request of the customer.

The present invention also provides a method for providing virtual fitting experience comprising steps of receiving input of customer data and clothing data, processing customer data, processing clothing data, generating fitting data, wherein the fitting data comprises graphic rendering of virtual fitting based on the customer data and the clothing data, displaying fitting data, storing the customer data, the clothing data and the fitting data and sending and receiving the customer data, the clothing data or the fitting data over an electronic network.

The customer data comprises body measurement data and one or more photographs of a customer, wherein the body measurement data comprises standard clothing size parameters, The step of processing customer data comprises a step of analyzing the customer body photograph and step of generating body measurement data for the customer based on the analysis.

The step of processing customer data further comprises a step of increasing or decreasing one of the standard clothing size parameters for the body measurement data of a customer, whereby a body template for the customer is modified by customer's choice.

The clothing data comprises fabric design data, fabric shape data, and standard clothing size parameters for a given clothes. The step of generating fitting data comprises a step of associating the spatial position of a graphic clothing model represented by the clothing data and the spacial position of a graphic human body model represented by the customer data.

The step of processing clothing data comprises a step of adjusting the fabric design data, the fabric shape data, and the standard clothing size parameters for a given clothes per request of the customer.

The advantageous effects of the present invention are: (1) customers can create their own character accurately resembling their body and face; (2) the character is virtually fitted with styles of different clothes achieving magnificent effects on customers' satisfaction; (3) customers can use their character as a mirror or mannequin. They can put clothes on the character and they can purchase the products if they are interested; (4) the character can be changed by increase or decrease of the size of full body parts, such as length of arms and legs, and radius of head, height, weight, and etc; (5) adequate size of clothing can be automatically recommended for a given character because the character gives specific size information and saves on the customer's data file; (6) customers can use tools to select certain information to change style, color and size of clothes; (7) customers can design their own clothes using 2D/3D software program. They can upload any images to database to make their own clothes; (8) customers can request and submit their design to our database so that they can wear custom-built or custom-designed clothes; (9) the 2D/3D character can be shown on many different backgrounds thus people can select different clothes to many different places, locations, and situations; (10) the character may rotate 360 degree that people can actually see the style in various angles; (11) the character can walk, turn, and make various poses for snap shots; (12) customers can make their own closet using the database server at anytime; (13) customers can purchase products which fit most accurate on them without actual trying; (14) the software program of the present invention solves the online shopping weakness and will derive more revenue; and (15) customers can save their 2D/3D character's snap shots on their smart phone and it can be sent to anybody using multi-media messages.

### BRIEF DESCRIPTION OF THE DRAWINGS

The accompanying drawings illustrate the best embodiments of the present invention. In the drawings:

FIG. 1 is a block diagram showing a system for providing virtual fitting experience according to the present invention; and

FIG. 2 is a flow diagram showing a method for providing virtual fitting experience according to the present invention.

### DESCRIPTION OF PREFERRED EMBODIMENTS

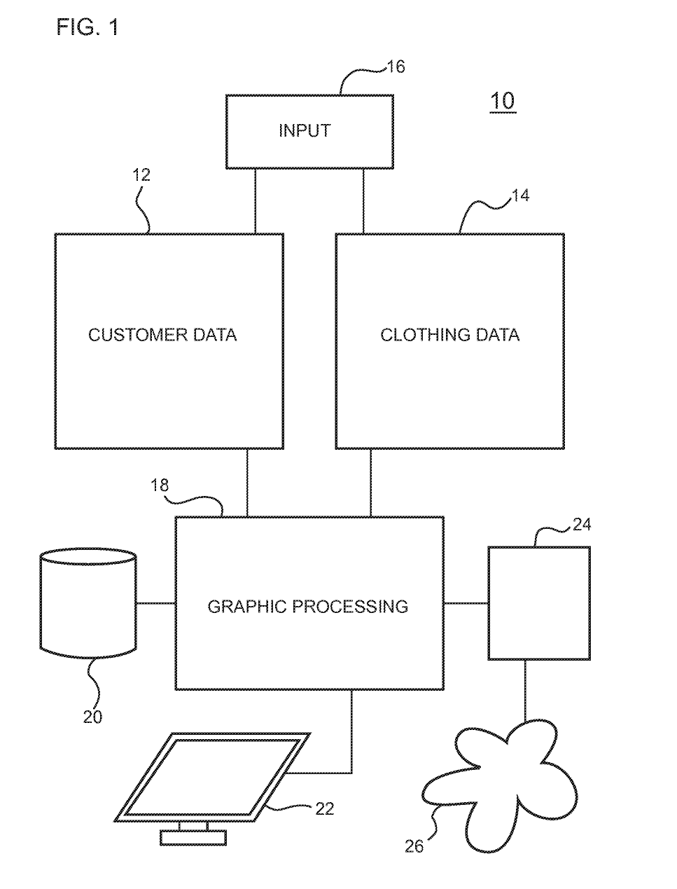

FIG. 1 shows a system 10 for providing virtual fitting experience. The system 10 comprises a customer data module 12 that processes customer data, a clothing data module 14 that processes clothing data, an input module 16 that receives the customer data and the clothing data, a graphic processing module 18 that generates fitting data, a database module 20 that stores the customer data, the clothing data and the fitting data and an output module 22 that displays fitting data. The fitting data comprises graphic rendering of virtual fitting based on the customer data and the clothing data.

The system 10 further comprises a communication module 24 that sends and receives the customer data, the clothing data or the fitting data over an electronic network 26. The system can be implemented with a computer graphic program that simulates the experience of trying garments. The program maximizes its utility in applying online shopping application to clothing selling.

The customer data comprises body measurement data which includes standard clothing size parameters. The system can generate and provide 2 dimensional and/or 3 dimensional (the “2D/3D”) character(s) which is very similar to customers' actual body shape. Customers' body measurement is needed to provide the most accurate results.

The customer data further comprises one or more photographs of a customer. The customer data module 12 analyzes the customer body photograph and generates body measurement data for the customer. The customer data module 12 compares the customer body photograph with pre-installed body templates, chooses a closest body template, and uses body measurement data of the body template as the body measurement data for the customer. The 2D/3D character generates actual fits and styles of different clothes, therefore, customers can create their own characters that have very similar body shape in 2 dimensional and/or 3 dimensional character(s). It achieves magnificent effects on customers' satisfaction because it provide visual image in 2D/3D. Templates may be used to relieve burden of handing exact details of a customer's body dimension and appearance such as face, hair or skin color. Customer's data are matched to a most similar template. Variations from the template are provided as customer's choice or the program itself suggests recommended variation.

The customer data further comprises the face image of a customer. The customer data module 12 compares the face image with pre-installed face templates, chooses a closest face template, and morphs the customer's face image to the chosen face template.

The customer data further comprises a background image. The background image is input by the customer or chosen from pre-installed background images by the customer. A customer recognizes value of clothing in setting that is most familiar to her, that is, her own body, face, and living spaces such as home, car, workplace, etc. The present invention can also handle such background information graphically in 2D/3D, and display a simulated image of a customer wearing a particular garment and sitting, standing or making some pose in a particular background. Customers can use their character as a mirror or mannequin. They can put clothes on the character and they can purchase the products if they are interested. The 2D/3D character illustrates customer's face and body shape such as, length, weight, height, and etc. Customers can also place their face image by uploading their digital photo. The 2D/3D character can be shown on many different backgrounds thus people can select different clothes to many different places, locations, and situations.

The customer data module 12 increases or decreases one of the standard clothing size parameters for the body measurement data of a customer, whereby the body template for the customer is modified by customer's choice. The 2D/3D character can increase or decrease the size of full body parts, such as length of arms and legs, and radius of head, height, weight, and etc. Children rapidly grow and parents are always curious how clothes would fit their child after several months, 1 year, etc. The program provides future appearance by features of changing body dimensions for an inputted figure.

The clothing data comprises fabric design data, fabric shape data, and standard clothing size parameters for a given clothes.

The graphic processing module 18 associates the spatial position of a graphic clothing model represented by the clothing data and the spacial position of a graphic human body model represented by the customer data. The 2D/3D character gives specific size information and saves on the customer's data file. Customers can click or drag shirts, pants, hand bags, earrings, and etc to see how character looks on the 2D/3D character. In generating fitting data, fabric of clothing is pulled downward by gravity, and contact by surface of the character stops downward movement of the fabric. The fabric is suspended from the contact points. Finite number of points on the surface of the character are chosen for reasonable computation load. For standard pose such as standing straight, computed result for templates may be provided in advance.

The database module 20 comprises a customer closet that stores the customer data, the clothing data and the fitting data for a particular customer. The 2D/3D character and clothes can be saved in our database server. Customers can make their own closet using our database server at anytime. The program provides data customized for a customer's history of choice, actual buying, preference, etc. The program systematically stores and manages data for a customer's personal characteristics and garments and accessories in which the customer is interested. The program handles all operations including input, analysis, process, display, transmission, etc. for the data. The program performs these functions for multiple customers.

The graphic processing module 18 changes the pose of the graphic human body model and generates the fitting data for the changed pose. The 2D/3D character may rotate 360 degree that people can actually see the style in various angles. The 2D/3D character can walk, turn, and make various poses for snap shots. The program graphically models a customer's body and provides 3D display of the body as the graphical body is assuming a pose of the customer's choice.

The clothing data modules 14 adjusts the fabric design data, the fabric shape data, and the standard clothing size parameters for a given clothes per request of the customer. Customers can use tools to select certain information to change style, color and size of clothes. Customers can design their own clothes using the system of the present invention. They can request any modifications or upload any images to database to make their own clothes.

The program provides 2D/3D graphical model of garments from a single photo of a garment. A photograph may be obtained by capturing or downloading image from the Internet, scanning from a magazine, etc. The program finds a close match, for the garment expressed by the photograph, from pre-installed data for popular garment shape, and applies the fabric design of the photograph to the match. Adjusting of the matched garment shape is possible for different sizes such as small, medium, large and for different types such as slim and oversize.

The standard clothing size parameters include height, bust, back, waist, hip, back-waist length, chest, neckband, shirt sleeve, and/or inseam. The parameters can be measured from photographs of customer taken under directions to provide accurate views. The parameters link the customer data and the clothing data. The parameters are used to choose proper template for body, templates are developed for different combination of standard clothing size. Deviations from the template can be computed and reflected in the fitting data. Customers can request and submit their design to our database so that they can wear custom-built or custom-designed clothes. The program provides comparison of trying different sizes of the same clothing so that the customer can review the best fitting without actually trying the clothes.

The system of the present invention can be used on smart phones. The program is compatible with mobile communication protocol and runs under operating systems for cell phones.vCustomers can save their 2D/3D character's snap shots on their smart phone and it can be sent to anybody using multi-media messages. Personal computers and other personal electronic devices can also be used. Such terminal devices for the customer include the input and output modules. An internet based server include the other modules and performs centralized functions for multiple customers.

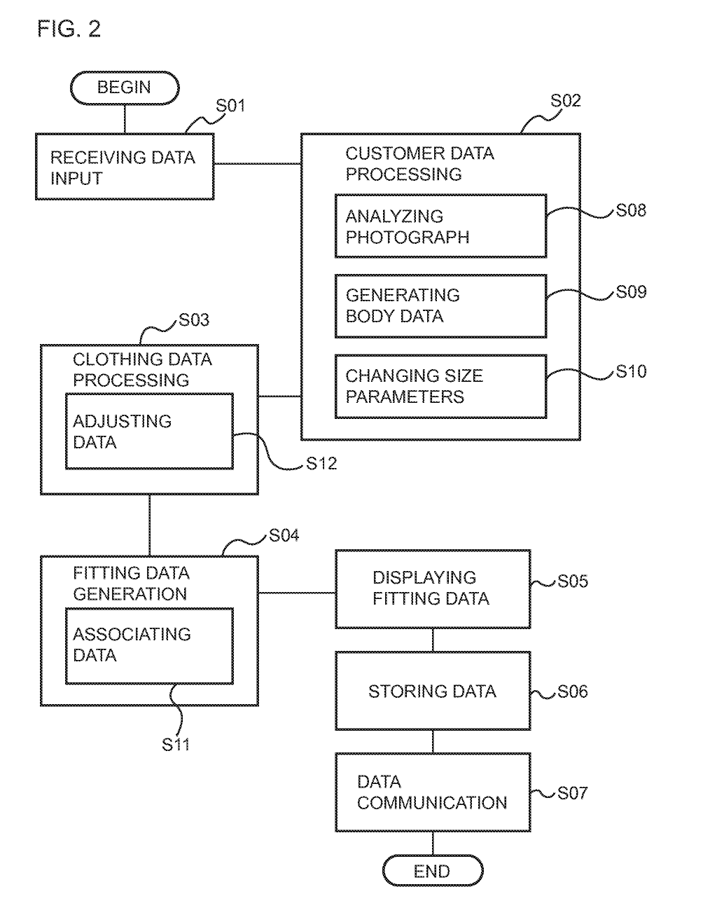

FIG. 2 shows a method for providing virtual fitting experience. The method comprises step S01 of receiving input of customer data and clothing data, step S02 of processing customer data, step S03 of processing clothing data, step S04 of generating fitting data, wherein the fitting data comprises graphic rendering of virtual fitting based on the customer data and the clothing data, step S05 of displaying fitting data, step S06 of storing the customer data, the clothing data and the fitting data and step S07 of sending and receiving the customer data, the clothing data or the fitting data over an electronic network. A customer can input photos of clothing or accessory, or her own illustration. The program graphically models the input data and may use templates to reduce burden of handling real world objects and may provide some degree of departure or variation from a particular template to effectively simulate the input design.

The customer data comprises body measurement data and one or more photographs of a customer, wherein the body measurement data comprises standard clothing size parameters, The step S02 comprises a step S08 of analyzing the customer body photograph and step S09 of generating body measurement data for the customer based on the analysis.

The step S02 further comprises a step S09 of increasing or decreasing one of the standard clothing size parameters for the body measurement data of a customer, whereby a body template for the customer is modified by customer's choice.

The clothing data comprises fabric design data, fabric shape data, and standard clothing size parameters for a given clothes. The step S04 comprises a step S10 of associating the spatial position of a graphic clothing model represented by the clothing data and the spacial position of a graphic human body model represented by the customer data.

The step S03 comprises a step S11 of adjusting the fabric design data, the fabric shape data, and the standard clothing size parameters for a given clothes per request of the customer.

This invention has been described with reference to certain specific embodiments. However, it is to be understood that modifications and substitutions can be made by an engineer without departing from the scope thereof.

1. A system for providing virtual fitting experience comprising:
a) a customer data module that processes customer data;
b) a clothing data module that processes clothing data;
c) an input module that receives the customer data and the clothing data;
d) a graphic processing module that generates fitting data
e) a database module that stores the customer data, the clothing data and the fitting data; and
f) an output module that displays fitting data;
wherein the fitting data comprises graphic rendering of virtual fitting based on the customer data and the clothing data.

2. The system of claim 1, further comprising a communication module that sends and receives the customer data, the clothing data or the fitting data over an electronic network.

3. The system of claim 2, wherein the customer data comprises body measurement data, wherein the body measurement data comprises standard clothing size parameters.

4. The system of claim 3, wherein the customer data further comprises one or more photographs of a customer, wherein the customer data module analyzes the customer body photograph and generates body measurement data for the customer.

5. The system of claim 4, wherein the customer data module compares the customer body photograph with pre-installed body templates, chooses a closest body template, and uses body measurement data of the body template as the body measurement data for the customer.

6. The system of claim 3, wherein the customer data further comprises the face image of a customer, wherein the customer data module compares the face image with pre-installed face templates, chooses a closest face template, and morphs the customer's face image to the chosen face template.

7. The system of claim 3, wherein the customer data further comprises a background image, wherein the background image is input by the customer or chosen from pre-installed background images by the customer.

8. The system of claim 3, wherein the customer data module increases or decreases one of the standard clothing size parameters for the body measurement data of a customer, whereby the body template for the customer is modified by customer's choice.

9. The system of claim 2, wherein the clothing data comprises fabric design data, fabric shape data, and standard clothing size parameters for a given clothes.

10. The system of claim 9, wherein the graphic processing module associates the spatial position of a graphic clothing model represented by the clothing data and the spacial position of a graphic human body model represented by the customer data.

11. The system of claim 10, wherein the database module comprises a customer closet that stores the customer data, the clothing data and the fitting data for a particular customer.

12. The system of claim 10, the graphic processing module changes the pose of the graphic human body model and generates the fitting data for the changed pose.

13. The system of claim 9, wherein the clothing data modules adjusts the fabric design data, the fabric shape data, and the standard clothing size parameters for a given clothes per request of the customer.

14. The system of claim 2, wherein the customer data comprises body measurement data, wherein the body measurement data comprises standard clothing size parameters, wherein the customer data further comprises one or more photographs of a customer, wherein the customer data module analyzes the customer body photograph and generates body measurement data for the customer, wherein the customer data module compares the customer body photograph with pre-installed body templates, chooses a closest body template, and uses body measurement data of the body template as the body measurement data for the customer, wherein the customer data further comprises the face image of a customer, wherein the customer data module compares the face image with pre-installed face templates, chooses a closest face template, and morphs the customer's face image to the chosen face template, wherein the customer data further comprises a background image, wherein the background image is input by the customer or chosen from pre-installed background images by the customer, wherein the customer data module increases or decreases one of the standard clothing size parameters for the body measurement data of a customer, whereby the body template for the customer is modified by customer's choice, wherein the clothing data comprises fabric design data, fabric shape data, and standard clothing size parameters for a given clothes, wherein the graphic processing module associates the spatial position of a graphic clothing model represented by the clothing data and the spacial position of a graphic human body model represented by the customer data, wherein the database module comprises a customer closet that stores the customer data, the clothing data and the fitting data for a particular customer, the graphic processing module changes the pose of the graphic human body model and generates the fitting data for the changed pose, wherein the clothing data modules adjusts the fabric design data, the fabric shape data, and the standard clothing size parameters for a given clothes per request of the customer.

15. A method for providing virtual fitting experience comprising steps of:
a) receiving input of customer data and clothing data;
b) processing customer data;
c) processing clothing data;
d) generating fitting data, wherein the fitting data comprises graphic rendering of virtual fitting based on the customer data and the clothing data; and
e) displaying fitting data.

16. The method of claim 15, further comprising steps of:
i) storing the customer data, the clothing data and the fitting data; and
ii) sending and receiving the customer data, the clothing data or the fitting data over an electronic network.

17. The method of claim 16, wherein the customer data comprises body measurement data and one or more photographs of a customer, wherein the body measurement data comprises standard clothing size parameters, wherein the step of processing customer data comprises a step of analyzing the customer body photograph and step of generating body measurement data for the customer based on the analysis.

18. The method of claim 17, wherein the step of processing customer data further comprises a step of increasing or decreasing one of the standard clothing size parameters for the body measurement data of a customer, whereby a body template for the customer is modified by customer's choice.

19. The method of claim 16, wherein the clothing data comprises fabric design data, fabric shape data, and standard clothing size parameters for a given clothes, wherein the step of generating fitting data comprises a step of associating the spatial position of a graphic clothing model represented by the clothing data and the spacial position of a graphic human body model represented by the customer data.

20. The method of claim 19, wherein the step of processing clothing data comprises a step of adjusting the fabric design data, the fabric shape data, and the standard clothing size parameters for a given clothes per request of the customer.
